(19) United States
(12) Patent Application Publication
(10) Pub. No.: US 2017/0255906 A1
(43) Pub. Date: Sep. 7, 2017

(54) CANDIDATE SELECTION FOR JOB SEARCH RANKING

(71) Applicant: Linkedln Corporation, Mountain View, CA (US)

(72) Inventors: Benjamin Hoan Le, San Jose, CA (US); Dhruv Arya, Sunnyvale, CA (US)

(21) Appl. No.: 15/061,249

(22) Filed: Mar. 4, 2016

(51) Int. Cl. G06Q 10/10; G06F 17/30; G06Q 50/00

(52) U.S. Cl. CPC G06Q 10/1053; G06Q 50/01; G06F 17/30867; G06F 17/3053; G06F 17/30525

(57) ABSTRACT

An online social networking system receives a job search query from a member, and retrieves job postings from a database. The system applies a first scoring model to the retrieved job postings, thereby generating a first coarse ranking of the retrieved job postings. The system then identifies a top percentage or number of job postings from the first coarse ranking, and applies a second scoring model to the top percentage or number of job postings, thereby generating a second fine ranking of the retrieved job postings. The system then displays the second fine ranking of the retrieved job postings on a computer display device.

### TECHNICAL FIELD

The present disclosure generally relates to computer technology for solving technical challenges in electronic communications. More specifically, the present disclosure relates to the ranking of job search results using candidate selection features.

### BACKGROUND

Online social and professional networking services are becoming increasingly popular, with many such services boasting millions of active members. In particular, the professional networking website Linkedln has become successful at least in part because it allows members to actively search for jobs.

### BRIEF DESCRIPTION OF THE DRAWINGS

Some embodiments of the technology are illustrated, by way of example and not limitation, in the figures of the accompanying drawings.

FIG. 1 is a block diagram illustrating a client-server system, in accordance with an example embodiment.

FIG. 2 is a block diagram showing the functional components of a social networking service, including a data processing module referred to herein as a search engine, for use in generating and providing search results for a search query, consistent with some embodiments of the present disclosure.

FIG. 3 is a block diagram illustrating a job posting indexer, in accordance with an example embodiment.

FIG. 4 is a screen capture illustrating a job posting, in accordance with an example embodiment.

FIG. 5 is a block diagram illustrating an entity extractor, in accordance with an example embodiment.

FIG. 6 is a block diagram illustrating a job search handler, in accordance with an example embodiment.

FIG. 7 is a screen capture illustrating an example skills and endorsements section of a member profile, in accordance with an example embodiment.

FIG. 8 is a diagram illustrating filtering of job posting results from training data, in accordance with an example embodiment.

FIGS. 9A and 9B are a flowchart illustrating a process to use candidate selection for job search ranking.

FIG. 10 is a block diagram illustrating a representative software architecture, which may be used in conjunction with various hardware architectures herein described.

FIG. 11 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

### Overview

The present disclosure describes, among other things, methods, systems, and computer program products that individually provide various functionality. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

In a typical online system that searches through documents in a database, for example an online social networking system having a job posting functionality, the system retrieves documents based on a query, scores or ranks the retrieved documents, and then displays a portion of the retrieved documents based on the scoring or ranking. The system will score all documents that were retrieved based on the search, and this generates a sorted top hits list. For selective or narrow queries wherein the retrieved result set is relatively small, scoring all of the documents is not an issue. However, for expansive or broad queries that retrieve a million or more documents, the scoring of all of these documents can cause performance problems in the online system. Indeed, an attempt to score all documents could cause the online system to time-out, and no documents would be returned to the user in response to the user's query. This of course is confusing to a user, and leads to reduced viewings of job postings and reduced applications for jobs. This situation is exacerbated when complex and sophisticated scoring models are used that require computation of expensive features.

To address this issue, a system can employ what can be referred to as early termination with static rankings. With this approach, a static rank is calculated for every document retrieved in a search. Then, during the scoring phase, only a top percentage of documents by static rank are scored. Although this approach works well in improving performance, the relevance of the returned search results will only be unaffected if the static rank of a document is somewhat correlated with the final score attributed to the document. If this is not the case however, then documents with low static ranks that are highly relevant to the user's query will not surface and therefore will not be returned to the user. This can be a particular issue in relation to job search applications. That is, due to the personalized nature of a job search, a scoring model normally heavily weights query related features and search homophily features. Thus, for every user-query pair, it is not possible to train a global static ranking model with high recall of relevant documents after early termination.

Consequently, in another embodiment, the system can employ what can be referred to a candidate selection of retrieved documents before a scoring phase is executed. In this approach, a separate first scoring model is applied online to rank all retrieved documents. A top percentage of documents from this first scoring model are considered as candidate documents to be passed to a second scoring model. As such, the system has a two pass scoring pipeline. In the first scoring model, documents are coarsely ranked, then early terminated by taking a certain top percentage of these documents or a top number of these documents, and then finely ranked by the second scoring model. Since the first model is only a coarse ranking, a very cheap scoring model can be used, thereby optimizing for the recall of relevant documents. The second scoring model is then a more expensive scoring model that results in a fine, precise ranking of the candidate documents. The overall performance of the system is greatly improved by applying the second more expensive ranking model to only a subset of the retrieved documents. In an embodiment, when the first model is applied online, query- and searcher-related features can be used in the ranking (which are generally unavailable in systems using the aforementioned static ranks). Consequently, this results in a superior ranking function over a static ranking system and a better recall of relevant documents when applying early termination using those rankings.

In an embodiment, the first cheap scoring model can simulate static ranking by using only document quality features such as how recently a job has been posted and historical click through rates of a job posting. These document quality features can be weighted. It is noted that even with a simple first scoring model with a small selection of features and un-optimized feature weights, an improved search system is realized with the two pass scoring.

In an embodiment, the feature set of the first scoring model can be expanded by adding more document quality features, and also adding query features such as similarity between the user query and job title. With a more complex feature set, rankings resulting from the first scoring model will be more accurate. This reduces the number of documents that are considered for candidate selection and the second model, which further increases system performance.

In an embodiment, the first scoring models are trained with an expanded feature set. Since the goal of the first scoring model is to optimize the recall of relevant documents in a top percentage or top number of documents, traditional learning algorithms are superfluous. Instead, the system can reduce the scoring to a classification problem. Specifically, given a query-document tuple, the document is classified as being relevant or not relevant to the searcher's query. Training data can be labeled by considering all clicked jobs as relevant and vice-versa. Logistic regression can be used to train weights. Logistic regression is well understood by those skilled in the art, and will not be described in further detail herein, in order to avoid occluding various aspects of this disclosure. Additionally, the system may use various other modelling techniques understood by those skilled in the art. For example, other modelling techniques may include other machine learning models such as a Naïve Bayes model, a support vector machines (SVM) model, a decision trees model, and a neural network model, all of which are understood by those skilled in the art.

Consequently, in light of the foregoing, in an example embodiment, on online social networking system receives a job search query from a member of the online social networking system. The system retrieves job postings from a database in the online social networking system using the job search query, and applies a first scoring model to the retrieved job postings, thereby generating a first coarse ranking of the retrieved job postings. The system identifies a top percentage or top number of job postings from the first coarse ranking, and then applies a second scoring model to the top percentage or top number of job postings, thereby generating a second fine ranking of the retrieved job postings. The system finally displays the second fine ranking of the retrieved job postings on a computer display device.

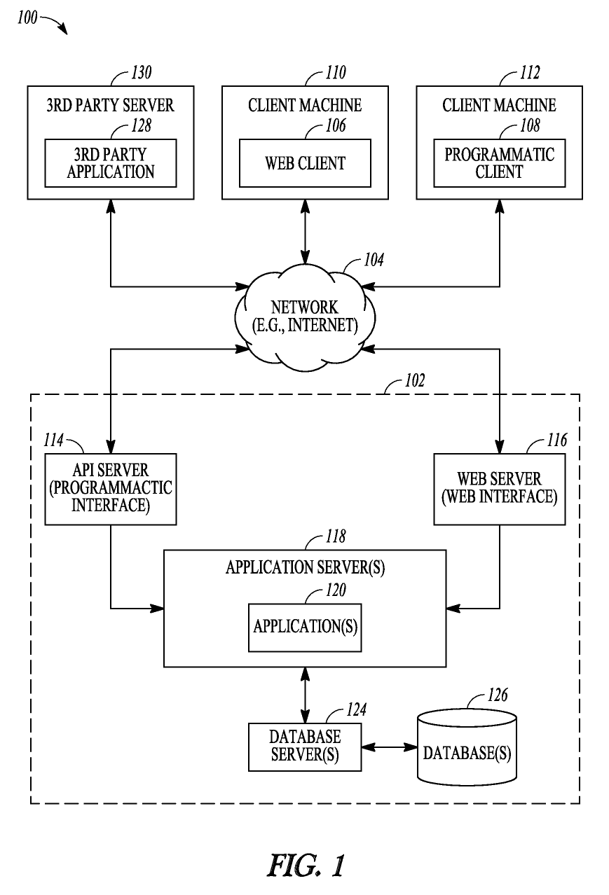

Any of the above-discussed embodiments can be implemented on a client-server system such as the system illustrated in FIG. 1. In FIG. 1, a networked system 102 provides server-side functionality via a network 104 (e.g., the Internet or a wide area network (WAN)) to one or more clients. FIG. 1 illustrates, for example, a web client 106 (e.g., a browser) and a programmatic client 108 executing on respective client machines 110 and 112.

An application program interface (API) server 114 and a web server 116 are coupled to, and provide programmatic and web interfaces respectively to, one or more application servers 118. The application server(s) 118 host one or more applications 120. The application server(s) 118 are, in turn, shown to be coupled to one or more database servers 124 that facilitate access to one or more databases 126. While the application(s) 120 are shown in FIG. 1 to form part of the networked system 102, it will be appreciated that, in alternative embodiments, the application(s) 120 may form part of a service that is separate and distinct from the networked system 102.

Further, while the client-server system 100 shown in FIG. 1 employs a client-server architecture, the present disclosure is, of course, not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the application(s) 120 via the programmatic interface provided by the API server 114.

FIG. 1 also illustrates a third party application 128, executing on a third party server 130, as having programmatic access to the networked system 102 via the programmatic interface provided by the API server 114. For example, the third party application 128 may, utilizing information retrieved from the networked system 102, support one or more features or functions on a website hosted by a third party. The third party website may, for example, provide one or more functions that are supported by the relevant applications 120 of the networked system 102.

In some embodiments, any website referred to herein may comprise online content that may be rendered on a variety of devices including, but not limited to, a desktop personal computer (PC), a laptop, and a mobile device (e.g., a tablet computer, smartphone, etc.). In this respect, any of these devices may be employed by a user to use the features of the present disclosure. In some embodiments, a user can use a mobile app on a mobile device (any of the machines 110, 112, and the third party server 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

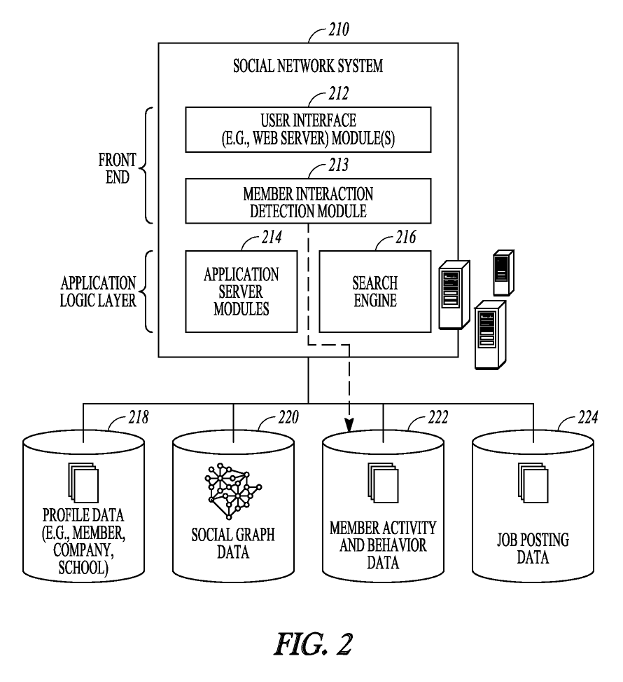

In some embodiments, the networked system 102 may comprise functional components of a social networking service. FIG. 2 is a block diagram showing the functional components of a social networking service, including a data processing module referred to herein as a search engine 216, for use in generating and providing search results for a search query, consistent with some embodiments of the present disclosure. In some embodiments, the search engine 216 may reside on the application server(s) 118 in FIG. 1. However, it is contemplated that other configurations are also within the scope of the present disclosure.

As shown in FIG. 2, a front end may comprise a user interface module (e.g., a web server 116) 212, which receives requests from various client computing devices, and communicates appropriate responses to the requesting client devices. For example, the user interface module(s) 212 may receive requests in the form of Hypertext Transfer Protocol (HTTP) requests or other web-based API requests. In addition, a member interaction detection module 213 may be provided to detect various interactions that members have with different applications 120, services, and content presented. As shown in FIG. 2, upon detecting a particular interaction, the member interaction detection module 213 logs the interaction, including the type of interaction and any metadata relating to the interaction, in a member activity and behavior database 222.

An application logic layer may include one or more various application server modules 214, which, in conjunction with the user interface module(s) 212, generate various user interfaces (e.g., web pages) with data retrieved from various data sources in a data layer. In some embodiments, individual application server modules 214 are used to implement the functionality associated with various applications 120 and/or services provided by the social networking service.

As shown in FIG. 2, the data layer may include several databases, such as a profile database 218 for storing profile data, including both member profile data and profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information is stored, for example, in the profile database 218. Once registered, a member may invite other members, or be invited by other members, to connect via the social networking service. A “connection” may constitute a bilateral agreement by the members, such that both members acknowledge the establishment of the connection. Similarly, in some embodiments, a member may elect to “follow” another member. In contrast to establishing a connection, the concept of “following” another member typically is a unilateral operation and, at least in some embodiments, does not require acknowledgement or approval by the member that is being followed. When one member follows another, the member who is following may receive status updates (e.g., in an activity or content stream) or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other objects, are stored and maintained within a social graph in a social graph database 220.

As members interact with the various applications 120, services, and content made available via the social networking service, the members' interactions and behavior (e.g., content viewed, links or buttons selected, messages responded to, etc.) may be tracked, and information concerning the members' activities and behavior may be logged or stored, for example, as indicated in FIG. 2, by the member activity and behavior database 222. This logged activity information may then be used by the search engine 216 to determine search results for a search query.

In some embodiments, the databases 218, 220, and 222 may be incorporated into the database(s) 126 in FIG. 1. However, other configurations are also within the scope of the present disclosure.

Although not shown, in some embodiments, the social networking service system 210 provides an API module via which applications 120 and services can access various data and services provided or maintained by the social networking service. For example, using an API, an application may be able to request and/or receive one or more navigation recommendations. Such applications 120 may be browser-based applications 120, or may be operating system-specific. In particular, some applications 120 may reside and execute (at least partially) on one or more mobile devices (e.g., phone or tablet computing devices) with a mobile operating system. Furthermore, while in many cases the applications 120 or services that leverage the API may be applications 120 and services that are developed and maintained by the organization operating the social networking service, nothing other than data privacy concerns prevents the API from being provided to the public or to certain third parties under special arrangements, thereby making the navigation recommendations available to third party applications 128 and services.

Although the search engine 216 is referred to herein as being used in the context of a social networking service, it is contemplated that it may also be employed in the context of any website or online services. Additionally, although features of the present disclosure are referred to herein as being used or presented in the context of a web page, it is contemplated that any user interface view (e.g., a user interface on a mobile device or on desktop software) is within the scope of the present disclosure.

In an example embodiment, when member profiles are indexed, forward search indexes are created and stored. The search engine 216 facilitates the indexing and searching for content within the social networking service, such as the indexing and searching for data or information contained in the data layer, such as profile data (stored, e.g., in the profile database 218), social graph data (stored, e.g., in the social graph database 220), and member activity and behavior data (stored, e.g., in the member activity and behavior database 222). The search engine 216 may collect, parse, and/or store data in an index or other similar structure to facilitate the identification and retrieval of information in response to received queries for information. This may include, but is not limited to, forward search indexes, inverted indexes, N-gram indexes, and so on.

Companies, recruiters, or other individuals or organizations may then post job postings to the social networking system. These job postings may be stored in job posting database 224 and may be available to members of the social networking service system 210 for search, perusal, and application.

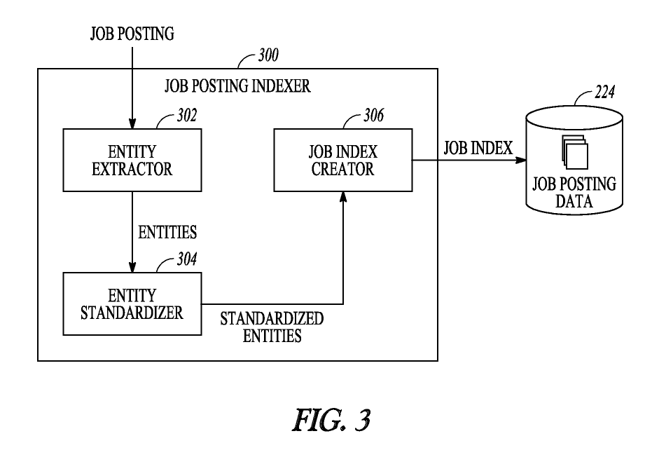

FIG. 3 is a block diagram illustrating a job posting indexer 300, in accordance with an example embodiment. The job posting indexer 300 may be located inside the application server module 214 of FIG. 2. The job posting indexer 300 may include an entity extractor 302, an entity standardizer 304, and a job index creator 306. The entity extractor 302 identifies entities within a job posting that match a set of predefined entities and extracts those entities from the job posting. The predefined entities may be specified by an administrator and the algorithm used by the entity extractor 302 to identify those features in a job posting may be an algorithm trained through machine learning. The entity standardizer 304 then standardizes the extracted entities so that entities that actually mean the same thing but are worded differently are treated the same. Thus, “software engineer,” “software programmer,” “software engineering,” and the like may all be standardized to “software engineer.” The normalized extracted entities from the job posting are then indexed by the job index creator 306 inside job posting database 224.

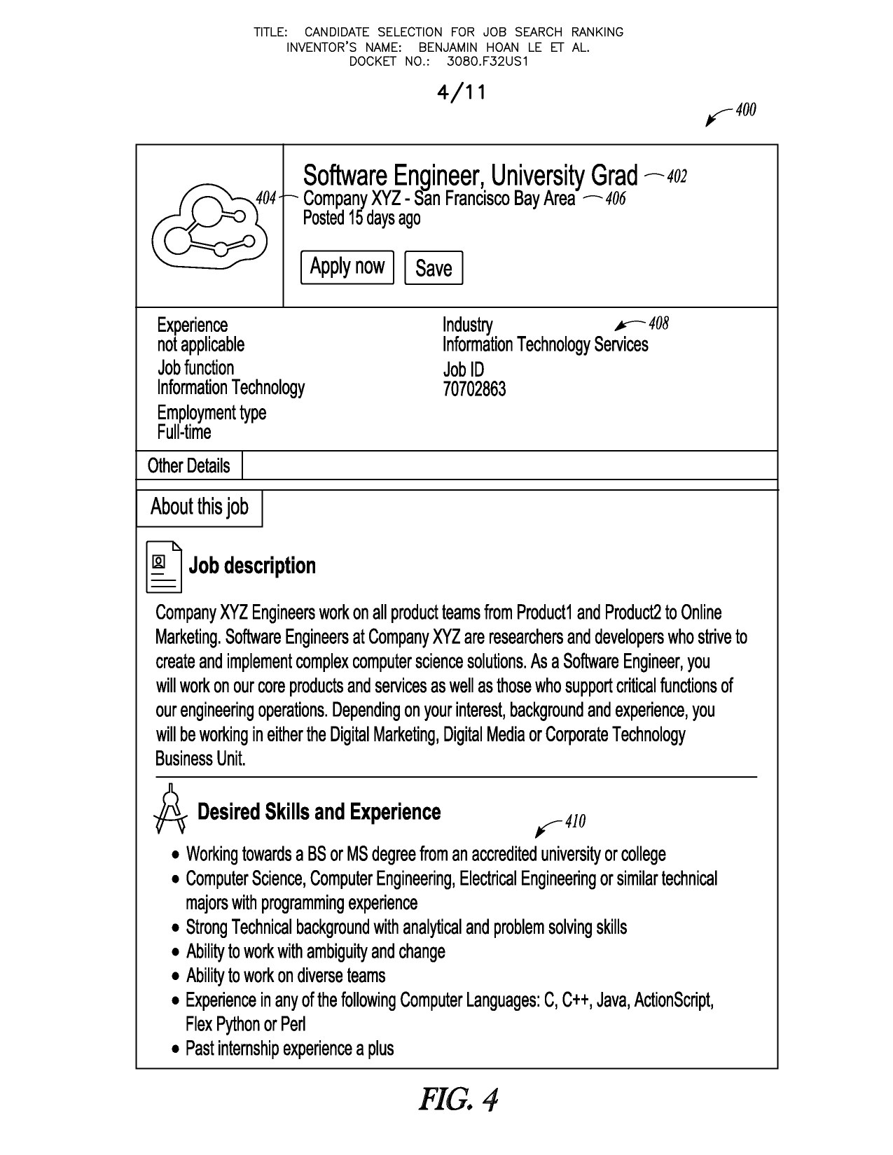

FIG. 4 is a screen capture illustrating a job posting 400, in accordance with an example embodiment. As described above, the entity extractor 302 may be programmed to look for several particular entities, including job title 402, company 404, location 406, industry 408, and skills 410 and extract them from the job posting.

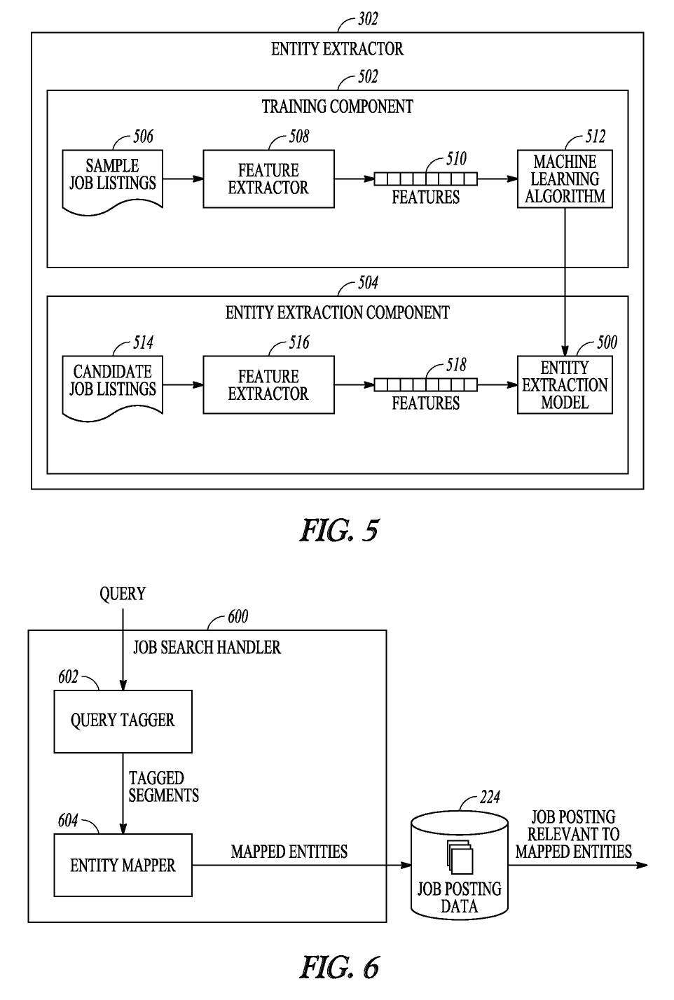

FIG. 5 is a block diagram illustrating an entity extractor 302, in accordance with an example embodiment. The entity extractor 302 may utilize machine learning processes to arrive at entity extraction model 500 used to extract entities from job postings. The entity extractor may comprise a training component 502 and an entity extraction component 504. The training component feeds sample job listings 506 into a feature extractor 508 that extracts one or more features 510 for the job listings 506. These features 510 are measurements useful in differentiating entities from one another and entities from non-entity information. For example, the features 510 may include, for each unit of text in the job listing, a location of the unit of text with respect to the job listing (because, for example, the job title entity may typically be located somewhere near the top of the job listing). The features 510 may also include, for example, metadata accompanying a unit of text, as well as terms surrounding the unit of text (also known as context). The features 510 are then fed into a machine learning algorithm 512, which acts to interpret the features as well as one or more labels provided by human administrators to learn how to identify which features of a unit of text are relevant to determining to which entity type the unit of text may correspond. The machine learning algorithm 512 produces the entity extraction model 500. In the entity extraction component 504, candidate job listings 514 are fed to a feature extractor 516 that extracts one or more features 518 from the candidate job listings 514. In an example embodiment, features 518 are identical to the features 510, although the values for the features will of course vary based on the job listings input.

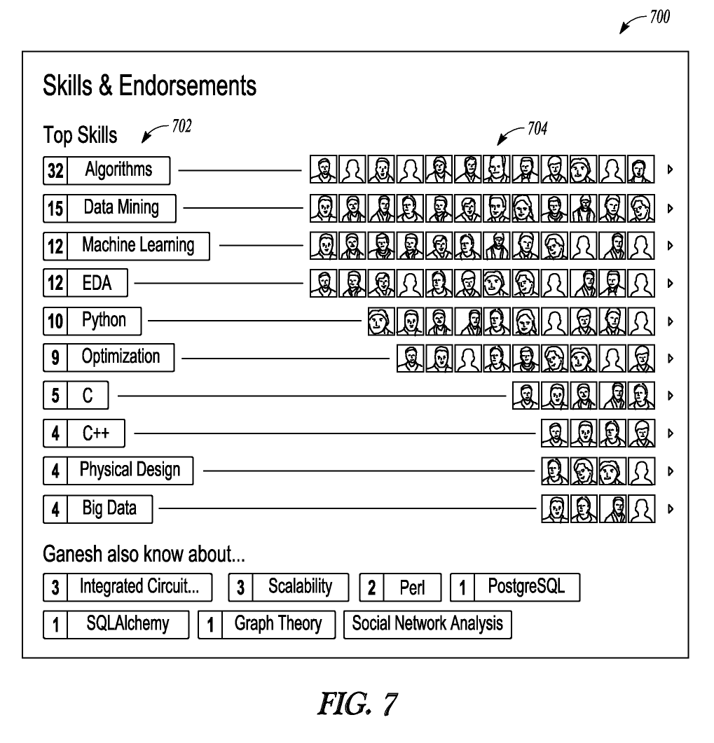

FIG. 6 is a block diagram illustrating a job search handler 600, in accordance with an example embodiment. The job search handler 600 may be located inside the application server module 214 of FIG. 2. When a searcher enters a query, a query tagger 602 is employed to segment the query and tag the segments into entity types that are important to the job search domain. In an example embodiment, these important entity types match the predetermined entities described above with respect to FIG. 3. Thus, these important entity types may include job title, company, location, industry, and skills. Thus, for example, the search query “software engineer Cambridge CompanyXYZ” may be segmented into “software engineer,” “Cambridge,” and “CompanyXYZ.” “Software engineer” may be tagged as the type “job title,” “Cambridge” may be tagged as the type “location,” and “Company XYZ” may be tagged as the type “company.”

The next step is to map the segments into specific entities. An entity mapper 604 may match the segments against a dictionary of corresponding types. Some segments may be ambiguous—Cambridge, for example, may refer to Cambridge, Mass. or Cambridge, England. A profile extracted for the searcher may be used to resolve ambiguities in a personalized way. For example, if the searcher is currently residing in the United States, the entity mapper 604 will be more likely to map Cambridge to Cambridge, Mass. than Cambridge, England. Likewise, the skills of the searcher (as denoted in the searcher's member profile) can be used to resolve a particularly ambiguous job title (e.g., “engineer” refers to “Software engineer” because the searcher has many software-related skills as opposed to a “structural engineer,” of which the searcher has no related skills).

In the social network, a node tends to be connected or interact with other nodes that are similar to it. In the context of a job search, in an example embodiment a job searcher tends to be interested in the jobs that require similar expertise as his or her skills. Members of a social network may be permitted to add skills to their profiles. These skills may be among thousands of standardized skills. Members can also endorse skills of other members in their network.

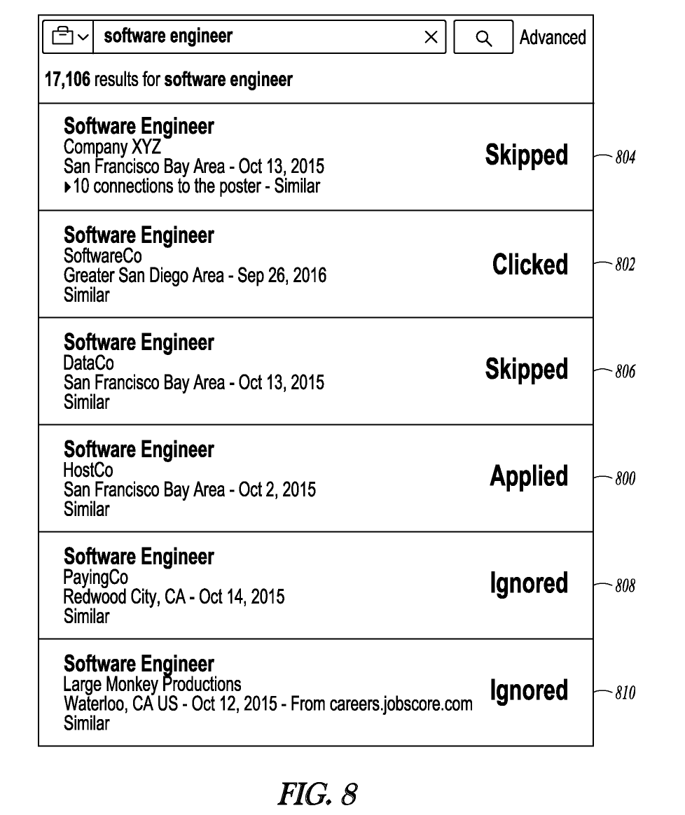

FIG. 7 is a screen capture illustrating an example skills and endorsements section 700 of a member profile, in accordance with an example embodiment. A list of the member's skills 702 is presented, ranked in order based on the number of endorsements provided for those skills, and photos of members 704 who made the corresponding endorsements are also presented.

Learning to rank, also known as machine-learned ranking, is an application of machine learning, typically supervised, semi-supervised, or reinforcement learning. Training data comprises lists of items with some partial order specified between items in each list. This order is typically induced by giving numerical or ordinal score or a binary judgement for each item. The ranking model's purpose is to rank, e.g., produce a permutation of items in lists in a way which is similar to the rankings in the training data in some sense.

In an example embodiment, existing features are generally divided into three categories: textural features, geographic features, and social features. The most traditional type of features is textural features. These features match the keywords in queries with different sections of a job description.

Geographic features relate to the location of the searcher/job opening. Social features indicate how the results socially relate to the searcher, based on factors such as how the searcher socially connects with the company posting the job (e.g., if he or she follows the company or has friends working at the company).

A traditional way to obtain training data is to use human experts to label the results. However, given a large training data set for a personal search, it is expensive to use human experts. At the same time, it is very hard for people other than the searcher to know the true relevance of the results. For example, for the query of “software engineer,” a new college graduate in the U.S. and an experienced candidate in Canada could be interested in very different results. In an example embodiment, log data is used as implicit feedback from searchers to generate training data. Log data comprises information about how users interact with results, such as which results they click on and which of the underlying jobs associated with the job postings they apply for.

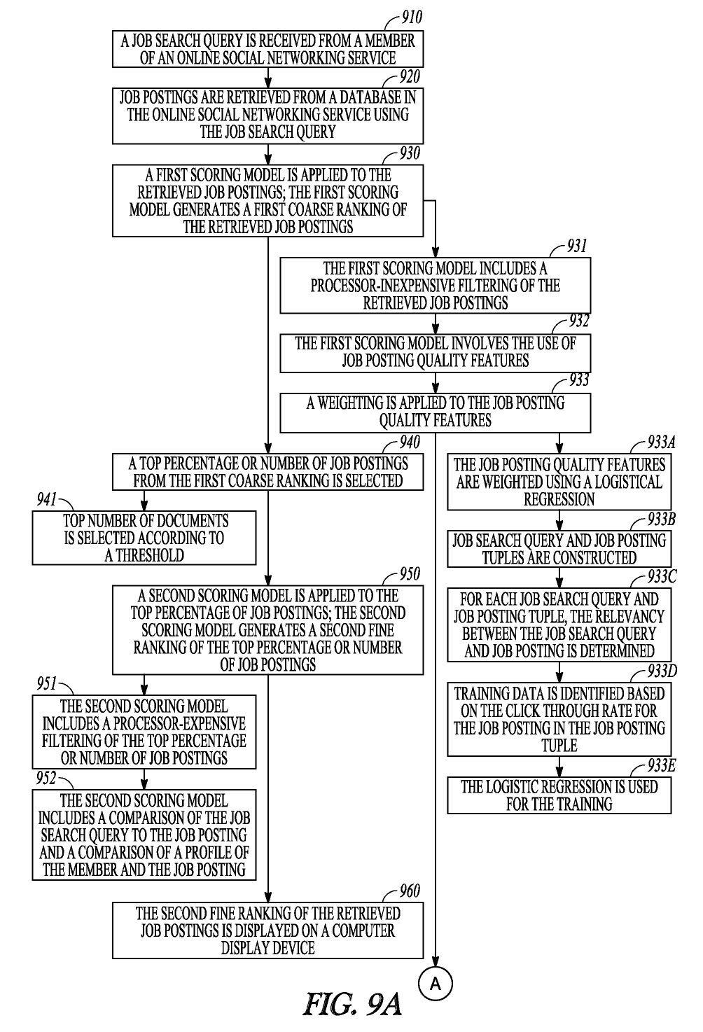

One problem with log data is something known as “position bias,” as users tend to interact with top results. Thus, labels inferred from user actions may be biased towards the ranking function generating the data. In order to counter the position bias, in an example embodiment, search results are randomized and shown to a small percentage of traffic. Additionally, log data may include not just information such as which documents the searcher clicked on but also which job positions the searcher applied for. Applying is a stronger signal of relevance than clicking, and thus a higher label may be assigned to applied results (considered as perfect results) and a lower label to clicked results (considered as good results). Results that received no interaction at all are considered as bad results, although for results shown below the last interacted one it cannot be determined whether the searcher deliberately did not interact with these results or whether the searcher did not look at them. In an example embodiment, results shown below the last result to be interacted with are discarded. FIG. 8 is a diagram illustrating filtering of job posting results from training data, in accordance with an example embodiment. As described above, the top results that have been applied for by a corresponding member, such as result 800, are considered perfect results. Top results that have not been applied for but have been clicked on, such as result 802, are considered good results. Results such as 804 and 806 that are higher than the lowest ranked interacted-with result (which here is result 800) but that themselves have not been interacted with are considered poor results, while any results below the lowest ranked interacted-with result (which here would include results 808 and 810) are simply ignored.

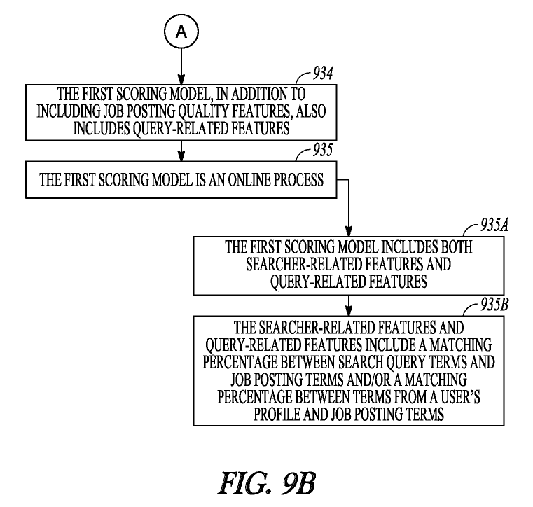

FIGS. 9A and 9B are a block diagram illustrating features and operations of systems and methods for candidate selection for job rankings. FIGS. 9A and 9B include a number of process blocks 910-960. Though arranged substantially serially in the example of FIGS. 9A and 9B, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring specifically to FIGS. 9A and 9B, at 910, a job search query is received from a member of an online social networking service. The job search query normally includes information such as the type of job for which the member is seeking, a job title of a job for which the member is seeking, a geographic location in which the member is interested, and/or a salary that the member is hoping to receive. At 920, job postings are retrieved from a database in the online social networking service using the job search query. This retrieval results in a set of job postings that satisfy the information that was provided by the member in the member's job search query. At 930, a first scoring model is applied to the retrieved job postings. The first scoring model generates a first coarse ranking of the retrieved job postings. The first scoring model is discussed in more detail below. At 940, a top percentage or number of job postings from the first coarse ranking is selected. In an embodiment, as illustrated at 941, a simple top number of documents according to a threshold of the job postings is selected, such as the top 1,000 documents. At 950, a second scoring model is applied to the top percentage or number of job postings. The second scoring model generates a second fine ranking of the top percentage of job postings. The second scoring model is discussed in more detail below. At 960, the second fine ranking of the retrieved job postings is displayed on a computer display device. These operations 910-960 provide an improved, intelligent selection of job posting documents that are sent to a scoring model, thereby improving the speed and performance of the system and increasing the relevancy of the job postings provided to a user in response to a user's job search.

The details of the first scoring model are as follows. As indicated at 931, the first scoring model includes a processor-inexpensive filtering of the retrieved job postings. A processor-inexpensive filtering involves any type of algorithm that does not require extensive processor cycles to filter and generate a list of job postings based either on job posting quality features or on the search query from the member. In a particular embodiment, as indicated at 932, the first scoring model involves the use of job posting quality features. Examples of job posting quality features include the age of a particular job posting, click through rates for a particular job posting, a job title of a particular job posting, and a premium status of the particular job posting. A job posting can be given premium status, for example, when the employer who posts the job pays a fee to the online social networking service. The use of job posting quality features optimizes the retrieval of relevant job postings. For example, when the click through rate of a job posting is high, that job posting has generated a good level of interest from other job seekers. Therefore, there is a greater possibility that that job posting will also be of interest to other job seekers as compared to a job posting that has a lower click through rate.

At 933, a weighting is applied to the job posting quality features. For example, the job title and job premium may be weighted more heavily than the age of a job posting, so that the job title and job premium will have a greater effect on whether a job posting is presented to a job seeker. At 933A, the job posting quality features are weighted using a logistical regression. Specifically, at 933B, job search query and job posting tuples are constructed. At 933C, for each job search query and job posting tuple, the relevancy between the job search query and job posting is determined. For example, a percentage of terms from the job search query that match or have equivalents with terms from the job posting is determined. At 933D, training data is identified based on the click through rate for the job posting in the job posting tuple. That is, data or terms from a job posting that has a high click through rate will more likely be used as training data than data or terms from a job posting that has a lower click through rate. At 933E, the logistic regression is used for the training.

In an embodiment, as indicated at 934, the first scoring model, in addition to including job posting quality features, can also include query-related features. For example, in this particular embodiment, the first scoring model can analyse a similarity between the job search query from the member and the titles of the jobs in the job postings, and/or a similarity between a profile of the member and the job posting.

As indicated at 951, the second scoring model comprises a processor-expensive filtering of the top percentage or number of job postings. A processor-expensive filtering involves any type of algorithm that requires extensive processor cycles to filter and generate a list of job postings based on the search query from the member. At 952, the processor-expensive filtering of the second scoring model includes a comparison of the job search query to the job posting and a comparison of a profile of the member and the job posting.

As indicated at 935, the first scoring model is an online process. As briefly discussed above, and as indicated in more detail at 935A, the first scoring model includes both searcher-related features and query-related features. More specifically, as indicated at 935B, the searcher-related features and query-related features can include a matching percentage between search query terms and job posting terms and/or a matching percentage between terms from a user's profile and job posting terms.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications, and so forth described in conjunction with FIGS. 1-9 are implemented in some embodiments in the context of a machine and an associated software architecture. The sections below describe representative software architecture(s) and machine (e.g., hardware) architecture(s) that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

### Software Architecture

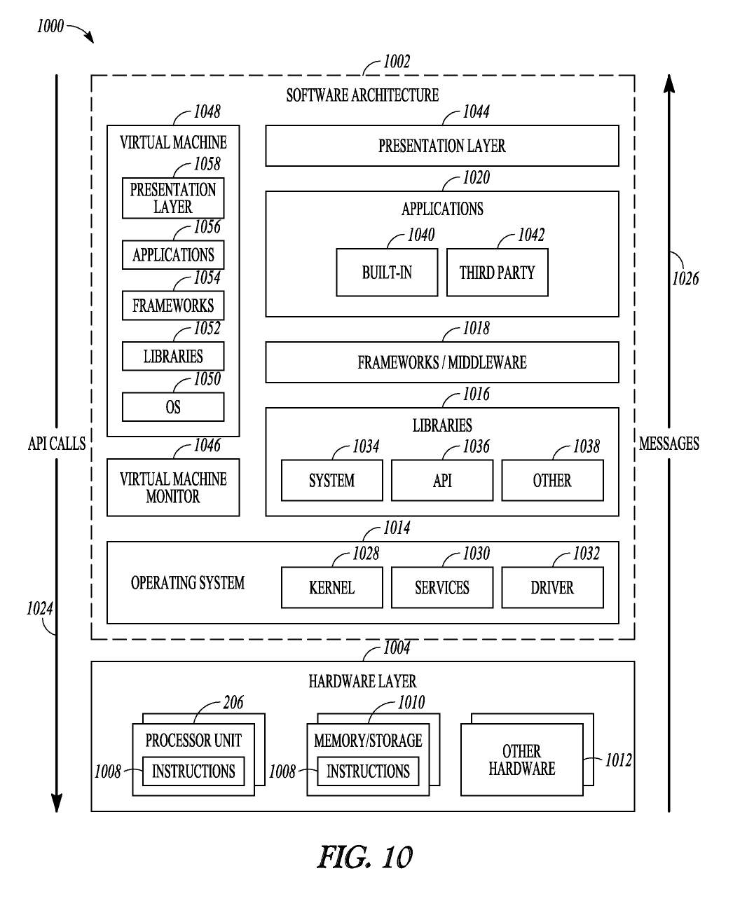

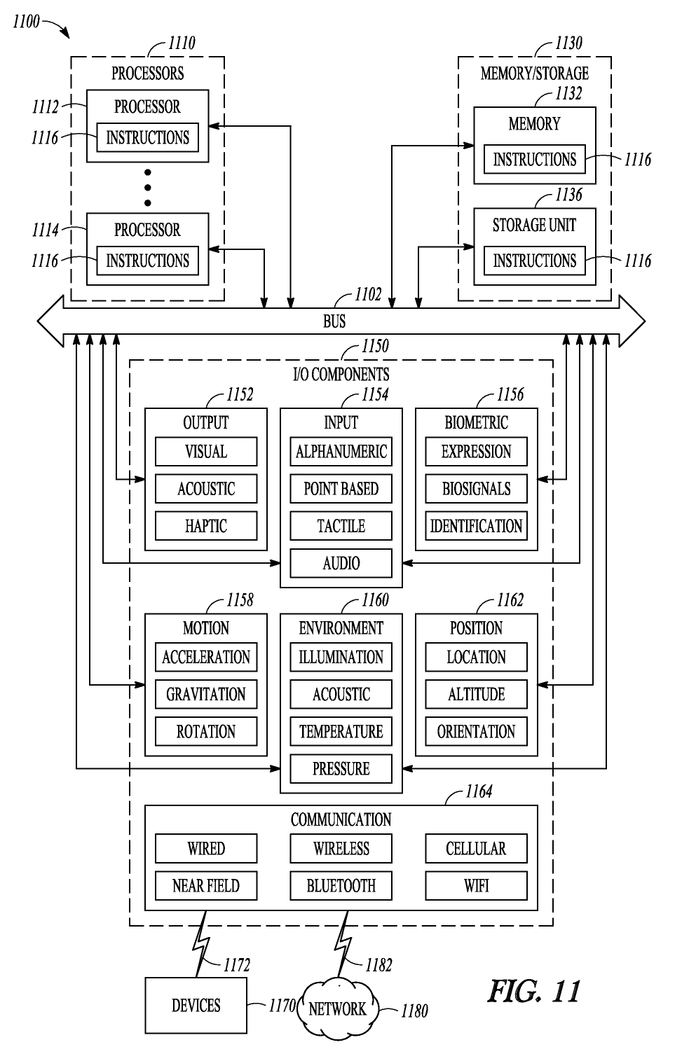

FIG. 10 is a block diagram 1000 illustrating a representative software architecture 1002, which may be used in conjunction with various hardware architectures herein described. FIG. 10 is merely a non-limiting example of a software architecture, and it will be appreciated that many other architectures may be implemented to facilitate the functionality described herein. The software architecture 1002 may be executing on hardware such as a machine 1100 of FIG. 11 that includes, among other things, processors 1110, memory/storage 1130, and I/O components 1150. A representative hardware layer 1004 is illustrated and can represent, for example, the machine 1100 of FIG. 11. The representative hardware layer 1004 comprises one or more processing units 1006 having associated executable instructions 1008. The executable instructions 1008 represent the executable instructions of the software architecture 1002, including implementation of the methods, modules, and so forth of FIGS. 1-9. The hardware layer 1004 also includes memory and/or storage modules 1010, which also have the executable instructions 1008. The hardware layer 1004 may also comprise other hardware 1012, which represents any other hardware of the hardware layer 1004, such as the other hardware illustrated as part of the machine 1100.

In the example architecture of FIG. 10, the software architecture 1002 may be conceptualized as a stack of layers where each layer provides particular functionality. For example, the software architecture 1002 may include layers such as an operating system 1014, libraries 1016, frameworks/middleware 1018, applications 1020, and a presentation layer 1044. Operationally, the applications 1020 and/or other components within the layers may invoke API calls 1024 through the software stack and receive responses, returned values, and so forth, illustrated as messages 1026, in response to the API calls 1024. The layers illustrated are representative in nature and not all software architectures have all layers. For example, some mobile or special purpose operating systems may not provide a layer of frameworks/middleware 1018, while others may provide such a layer. Other software architectures may include additional or different layers.

The operating system 1014 may manage hardware resources and provide common services. The operating system 1014 may include, for example, a kernel 1028, services 1030, and drivers 1032. The kernel 1028 may act as an abstraction layer between the hardware and the other software layers. For example, the kernel 1028 may be responsible for memory management, processor management (e.g., scheduling), component management, networking, security settings, and so on. The services 1030 may provide other common services for the other software layers. The drivers 1032 may be responsible for controlling or interfacing with the underlying hardware. For instance, the drivers 1032 may include display drivers, camera drivers, Bluetooth® drivers, flash memory drivers, serial communication drivers (e.g., Universal Serial Bus (USB) drivers), Wi-Fi drivers, audio drivers, power management drivers, and so forth depending on the hardware configuration.

The libraries 1016 may provide a common infrastructure that may be utilized by the applications 1020 and/or other components and/or layers. The libraries 1016 typically provide functionality that allows other software modules to perform tasks in an easier fashion than by interfacing directly with the underlying operating system 1014 functionality (e.g., kernel 1028, services 1030, and/or drivers 1032). The libraries 1016 may include system 1034 libraries (e.g., C standard library) that may provide functions such as memory allocation functions, string manipulation functions, mathematic functions, and the like. In addition, the libraries 1016 may include API 1036 libraries such as media libraries (e.g., libraries to support presentation and manipulation of various media formats such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1016 may also include a wide variety of other libraries 1038 to provide many other APIs to the applications 1020 and other software components/modules.

The frameworks 1018 (also sometimes referred to as middleware) may provide a higher-level common infrastructure that may be utilized by the applications 1020 and/or other software components/modules. For example, the frameworks 1018 may provide various graphic user interface (GUI) functions, high-level resource management, high-level location services, and so forth. The frameworks 1018 may provide a broad spectrum of other APIs that may be utilized by the applications 1020 and/or other software components/modules, some of which may be specific to a particular operating system or platform.

The applications 1020 include built-in applications 1040 and/or third party applications 1042. Examples of representative built-in applications 1040 may include, but are not limited to, a contacts application, a browser application, a book reader application, a location application, a media application, a messaging application, and/or a game application. The third party applications 1042 may include any of the built-in applications as well as a broad assortment of other applications. In a specific example, the third party application 1042 (e.g., an application developed using the AndroidTM or iOSTM software development kit (SDK) by an entity other than the vendor of the particular platform) may be mobile software running on a mobile operating system such as iOS™, Android™, Windows® Phone, or other mobile operating systems. In this example, the third party application 1042 may invoke the API calls 1024 provided by the mobile operating system, such as the operating system 1014, to facilitate functionality described herein.

The applications 1020 may utilize built-in operating system 1014 functions (e.g., kernel 1028, services 1030, and/or drivers 1032), libraries 1016 (e.g., system 1034, APIs 1036, and other libraries 1038), and frameworks/middleware 1018 to create user interfaces to interact with users of the system. Alternatively, or additionally, in some systems, interactions with a user may occur through a presentation layer, such as the presentation layer 1044. In these systems, the application/module “logic” can be separated from the aspects of the application/module that interact with a user.

Some software architectures utilize virtual machines. In the example of FIG. 10, this is illustrated by a virtual machine 1048. A virtual machine creates a software environment where applications/modules can execute as if they were executing on a hardware machine (such as the machine 1100 of FIG. 11, for example). A virtual machine is hosted by a host operating system (e.g., operating system 1014 in FIG. 10) and typically, although not always, has a virtual machine monitor 1046, which manages the operation of the virtual machine as well as the interface with the host operating system (e.g., operating system 1014). A software architecture executes within the virtual machine 1048, such as an operating system 1050, libraries 1052, frameworks/middleware 1054, applications 1056, and/or a presentation layer 1058. These layers of software architecture executing within the virtual machine 1048 can be the same as corresponding layers previously described or may be different.

### Example Machine Architecture and Machine-Readable Medium

FIG. 11 is a block diagram illustrating components of a machine 1100, according to some example embodiments, able to read instructions from a machine-readable medium (e.g., a machine-readable storage medium) and perform any one or more of the methodologies discussed herein. Specifically, FIG. 11 shows a diagrammatic representation of the machine 1100 in the example form of a computer system, within which instructions 1116 (e.g., software, a program, an application, an applet, an app, or other executable code) for causing the machine 1100 to perform any one or more of the methodologies discussed herein may be executed. The instructions transform the general, non-programmed machine into a particular machine programmed to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1116, sequentially or otherwise, that specify actions to be taken by the machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 may include processors 1110, memory/storage 1130, and I/O components 1150, which may be configured to communicate with each other such as via a bus 1102. In an example embodiment, the processors 1110 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1112 and a processor 1114 that may execute the instructions 1116. The term “processor” is intended to include multi-core processors that may comprise two or more independent processors (sometimes referred to as “cores”) that may execute instructions contemporaneously. Although FIG. 11 shows multiple processors 1110, the machine 1100 may include a single processor with a single core, a single processor with multiple cores (e.g., a multi-core processor), multiple processors with a single core, multiple processors with multiples cores, or any combination thereof.

The memory/storage 1130 may include a memory 1132, such as a main memory, or other memory storage, and a storage unit 1136, both accessible to the processors 1110 such as via the bus 1102. The storage unit 1136 and memory 1132 store the instructions 1116 embodying any one or more of the methodologies or functions described herein. The instructions 1116 may also reside, completely or partially, within the memory 1132, within the storage unit 1136, within at least one of the processors 1110 (e.g., within the processor's cache memory), or any suitable combination thereof, during execution thereof by the machine 1100. Accordingly, the memory 1132, the storage unit 1136, and the memory of the processors 1110 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 1116. The term “machine-readable medium” shall also be taken to include any medium, or combination of multiple media, that is capable of storing instructions (e.g., instructions 1116) for execution by a machine (e.g., machine 1100), such that the instructions, when executed by one or more processors of the machine (e.g., processors 1110), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1150 may include a wide variety of components to receive input, provide output, produce output, transmit information, exchange information, capture measurements, and so on. The specific I/O components 1150 that are included in a particular machine will depend on the type of machine. For example, portable machines such as mobile phones will likely include a touch input device or other such input mechanisms, while a headless server machine will likely not include such a touch input device. It will be appreciated that the I/O components 1150 may include many other components that are not shown in FIG. 11. The I/O components 1150 are grouped according to functionality merely for simplifying the following discussion and the grouping is in no way limiting. In various example embodiments, the I/O components 1150 may include output components 1152 and input components 1154. The output components 1152 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1150 may include biometric components 1156, motion components 1158, environmental components 1160, or position components 1162, among a wide array of other components. For example, the biometric components 1156 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1158 may include acceleration sensor components (e.g., accelerometer), gravitation sensor components, rotation sensor components (e.g., gyroscope), and so forth. The environmental components 1160 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1162 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1150 may include communication components 1164 operable to couple the machine 1100 to a network 1180 or devices 1170 via a coupling 1182 and a coupling 1172, respectively. For example, the communication components 1164 may include a network interface component or other suitable device to interface with the network 1180. In further examples, the communication components 1164 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1170 may be another machine or any of a wide variety of peripheral devices (e.g., a peripheral device coupled via a USB).

Moreover, the communication components 1164 may detect identifiers or include components operable to detect identifiers. For example, the communication components 1164 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1164, such as location via Internet Protocol (IP) geolocation, location via Wi-Fi® signal triangulation, location via detecting an NFC beacon signal that may indicate a particular location, and so forth.

### Transmission Medium

In various example embodiments, one or more portions of the network 1180 may be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1180 or a portion of the network 1180 may include a wireless or cellular network and the coupling 1182 may be a Code Division Multiple Access (CDMA) connection, a Global System for Mobile communications (GSM) connection, or another type of cellular or wireless coupling. In this example, the coupling 1182 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1116 may be transmitted or received over the network 1180 using a transmission medium via a network interface device (e.g., a network interface component included in the communication components 1164) and utilizing any one of a number of well-known transfer protocols (e.g., HTTP). Similarly, the instructions 1116 may be transmitted or received using a transmission medium via the coupling 1172 (e.g., a peer-to-peer coupling) to the devices 1170. The term “transmission medium” shall be taken to include any intangible medium that is capable of storing, encoding, or carrying the instructions 1116 for execution by the machine 1100, and includes digital or analog communications signals or other intangible media to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A system comprising:
a computer readable medium having instructions stored thereon, which, when executed by a processor, cause the system to:
receive a job search query from a member of an online social networking service;
retrieve job postings from a database in the online social networking service using the job search query;
apply a first scoring model to the retrieved job postings, thereby generating a first coarse ranking of the retrieved job postings;
identify a top percentage or number of job postings from the first coarse ranking;
apply a second scoring model to the top percentage or number of job postings, thereby generating a second fine ranking of the retrieved job postings; and
display the second fine ranking of the retrieved job postings on a computer display device.

2. The system of claim 1, wherein the first scoring model comprises a processor-inexpensive filtering of the retrieved job postings, and wherein the second scoring model comprises a processor-expensive filtering of the top percentage or number of job postings.

3. The system of claim 2, wherein the first scoring model comprises job posting quality features, thereby optimizing a retrieval of relevant job postings; and wherein the job posting quality features comprise one or more of an age of a particular job posting, click through rates for the particular job posting, a job title of the particular job posting, and a premium status of the particular job posting.

4. The system of claim 3, wherein the first scoring model comprises query-related features comprising a similarity between the job search query and a job title or a similarity between a profile of the member and the job posting.

5. The system of claim 3, comprising instructions to cause the system to apply a weighting factor to the job posting quality features.

6. The system of claim 5, comprising instructions for training the weighting factor using a logistic regression.

7. The system of claim 6, wherein the training comprises classifying the job postings as follows:
generating a job search query and a job posting tuple;
determining a relevancy of the job posting to the job search query in the job search query and job posting tuple;
identifying training data based on a click through rate for the job search query and job posting tuple; and
using the logistic regression for the training.

8. The system of claim 1, wherein the top percentage or number of job postings comprises a threshold number of documents.

9. The system of claim 1, wherein the first scoring model comprises an online process.

10. The system of claim 9, wherein the first scoring model comprises searcher-related features and query-related features; and wherein the searcher-related features and query-related features comprise one or more of a matching percentage between search query terms and job posting terms and a matching percentage between terms from a user's profile and job posting terms.

11. The system of claim 1, wherein the second scoring model comprises a comparison of the job search query to the job posting and a comparison of a profile of the member and the job posting.

12. A process comprising:
receiving a job search query from a member of an online social networking service;
retrieving job postings from a database in the online social networking service using the job search query;
applying a first scoring model to the retrieved job postings, thereby generating a first coarse ranking of the retrieved job postings;
identifying a top percentage or number of job postings from the first coarse ranking;
applying a second scoring model to the top percentage or number of job postings, thereby generating a second fine ranking of the retrieved job postings; and
displaying the second fine ranking of the retrieved job postings on a computer display device.

13. The process of claim 12, wherein the first scoring model comprises a processor-inexpensive filtering of the retrieved job postings, and wherein the second scoring model comprises a processor-expensive filtering of the top percentage of job postings.

14. The process of claim 13, wherein the first scoring model comprises job posting quality features, thereby optimizing a retrieval of relevant job postings; and wherein the job posting quality features comprise one or more of an age of a particular job posting, click through rates for the particular job posting, a job title of the particular job posting, and a premium status of the particular job posting.

15. The process of claim 14, wherein the first scoring model comprises query-related features comprising a similarity between the job search query and a job title.

16. The process of claim 14, comprising applying a weighting factor to the job posting quality features.

17. The process of claim 16, comprising training the weighting factor using a logistic regression.

18. The process of claim 17, wherein the training comprises classifying the job postings as follows:
generating a job search query and a job posting tuple;
determining a relevancy of the job posting to the job search query in the job search query and job posting tuple;
identifying training data based on a click through rate for the job search query and job posting tuple; and
using the logistic regression for the training.

19. The process of claim 12, wherein the top percentage or number of job postings comprises a threshold number of documents.

20. The process of claim 12, wherein the first scoring model comprises an online process;
and wherein the first scoring model comprises searcher-related features and query-related features; and wherein the searcher-related features and query-related features comprise one or more of a matching percentage between search query terms and job posting terms and a matching percentage between terms from a user's profile and job posting terms.

21. The process of claim 12, wherein the second scoring model comprises a comparison of the job search query to the job posting and a comparison of a profile of the member to the job posting.
